(19) United States
(12) Patent Application Publication
(10) Pub. No.: US 2026/0205019 A1
(43) Pub. Date: Jul. 16, 2026

(54) CONTROLLER CIRCUITS FOR AN ISOLATED DC-DC CONVERTER, CORRESPONDING CHIPSET, ISOLATED DC-DC CONVERTER, SWITCHED-MODE POWER SUPPLY AND METHOD OF OPERATION

(71) Applicant: STMicroelectronics International N.V., Geneva (CH)

(72) Inventor: Claudio Adragna, Monza (IT)

(21) Appl. No.: 19/443,819

(22) Filed: Jan. 8, 2026

(30) Foreign Application Priority Data
Jan. 13, 2025 (IT) 102025000000384

(51) Int. Cl. H02M 3/335

(52) U.S. Cl. CPC H02M 3/33569

(57) ABSTRACT

An isolated DC-DC converter has a transformer with primary, secondary and auxiliary windings, and a secondary-sensing regulation architecture. A primary-side controller has a PWM generator, a wake-up pulse detector, a supply voltage generator and control circuitry. A secondary-side controller has an error amplifier, a switching detector, a wake-up pulse generator, a supply voltage generator and control circuitry. The primary-side controller and the secondary-side controller produce respective supply voltages in such a way that, when the DC-DC converter enters an idle state, the controllers enter respective sleep states wherein the PWM generator and the error amplifier are not supplied, while retaining the ability of producing and detecting a wake-up pulse when necessary.

### CROSS-REFERENCE TO RELATED APPLICATIONS

This application claims the benefit of Italian patent application number 102025000000384, filed on Jan. 13, 2025, which application is hereby incorporated herein by reference.

### TECHNICAL FIELD

The present description relates to isolated DC-DC converters and methods, which may be used in energy-efficient switched-mode power supplies (SMPS).

### BACKGROUND

Most electrical and electronic household and office equipment consume electric power when switched off or when they are not performing their primary function. This wasted power is commonly referred to as standby power. The typical standby power per piece of equipment is low. However, considering the huge number of pieces permanently connected to the power line, the worldwide standby losses represent a significant fraction of total electricity use, and the waste of electrical energy associated with standby power and its associated CO2 emissions have been recognized as an issue.

Therefore, many programs that aim at reducing standby power have been put in place. Among them, the European Commission Regulation (EC) No. 1275/2008 of 17 Dec. 2008 (and later amendments) is particularly noticeable, insofar as it changed the criteria for energy labelling of household and office appliances, which now considers the energy consumed while these devices are not performing their primary function.

As far as the calculations of energy consumption are concerned, the Clause 4.5 of regulation IEC 62301 states that power measurements lower than 5 mW can be rounded down to zero. Hence, if during standby conditions the consumption of the appliance is lower than 5 mW, no contribution at all to energy consumption needs to be considered while the device is not performing its primary function. This facilitates achieving the highest labelling grade for energy consumption, corresponding to equipment that can be classified as “zero-standby power” type.

Some concepts relevant to the power supplies operated from the power line (also known as “offline power supplies” or “AC-DC power supplies”) will be now briefly introduced.

FIG. 1 is a circuit block diagram exemplary of a conventional offline power supply 10. The power supply 10 has a pair of input terminals configured for coupling to a power line 12 in order to receive an input AC voltage Vac therefrom (e.g., a 230 V alternating voltage at a frequency of 50 Hz), and a pair of output terminals configured for coupling to an electrical load 14 in order to provide an output DC voltage Vout thereto. The power supply 10 includes an optional EMI (electromagnetic interference) filter 102 coupled to the input terminal(s), an input rectification and filtering stage 104 coupled to the EMI filter 102, and a DC-DC converter stage 110 coupled to the input stage 104. The input stage 104 includes a rectifier stage 106 (e.g., a bridge rectifier such as a diode bridge) configured to carry out AC to DC conversion of the input voltage, followed by an input capacitor 108. The capacitor 108 substantially stores an input DC voltage Vin (obtained from rectification of the input AC voltage Vac), also referred to as “DC bus voltage”, with a significant AC ripple. The DC-DC converter 110 receives the DC bus voltage Vin and produces the output DC voltage Vout for the load 14 across an output capacitor 112 coupled between the output terminals of the offline power supply 10.

In order to protect the user against electrical shock hazard, many offline power supplies 10 use an isolated DC-DC converter 110, that is a DC-DC converter that has a galvanic isolation barrier. An isolated converter is thus a switched-mode power converter that has a primary side (connected to the AC line) and a secondary side (connected to the DC output) that are galvanically isolated. The galvanic isolation may be obtained by using a power transformer (hence, the denominations of primary side and secondary side, which are extended from the transformer windings to the entire sections of the DC-DC converter 110 connected to them), constructed to provide adequate insulation between the windings. The transformer enables energy transfer from the primary winding to the secondary winding by magnetic coupling without metallic connections.

In practically all converters, the output voltage Vout has to be regulated (i.e., kept at a constant value), despite the variations in the operating conditions (e.g., input voltage, output current, temperature, and the like) and aging. Regulation is conventionally achieved by using a negative feedback, closed-loop control. In isolated converters, closing the control loop poses a particular challenge: the output voltage is produced on the secondary side, whereas the controller and the power switch are implemented on the primary side, with the isolation barrier in between. There are essentially two approaches for transmitting a feedback signal from the secondary side to the primary side: secondary-sensing regulation (SSR) and primary-sensing regulation (PSR).

With secondary-sensing regulation, the feedback loop is closed by directly sensing the output voltage, and transferring the control signal from the secondary side to the PWM controller on the primary side through the isolation barrier, conventionally via an optocoupler or a functionally equivalent device such as a silicon-based isolator, or via RF coupling or capacitive coupling or magnetic coupling (in this regard, reference may be made to the Technical Article “Optocouplers and Silicon-based Galvanic Isolation Technology—How Do They Work?” by Texas Instruments, SSZT391, October 2019, and to the families of products available from companies of the STMicroelectronics groups under the trade designations ISOSD61, ISOSD61L, STISO621, and STISO620). An SSR arrangement for a DC-DC converter is exemplified in the circuit diagram of FIG. 2, which shows a feedback loop 20 having a first portion 22a implemented on the primary side and a second portion 22b implemented on the secondary side of the DC-DC converter.

The second portion 22b of the feedback loop 20 is coupled to the output node 202 of the DC-DC converter to sense the output voltage Vout and may include one or more of the following components: resistors R1, R2, RF1, RB1, and RB2; a capacitor CF1; a voltage regulator circuit VR (e.g., a TL431 integrated circuit or a derivative thereof such as TLV431, TL432, ATL431, KA431, LM431, TS431, 142EH19, and the like); a light-emitting device L (e.g., a LED); and optional capacitor CZ, Zener diode ZZ and resistor RZ collectively indicated as 24; all arranged as exemplified in FIG. 2. In particular, resistors R1 and R2 may be coupled in series between the output node 202 and ground GND2 to implement a voltage divider through which a current IR flows (e.g., resistor R1 may have a first terminal coupled to node 202 and a second terminal coupled to a node 204, and resistor R2 may have a first terminal coupled to node 204 and a second terminal coupled to ground GND2). In particular, resistor RF1 and capacitor CF1 may be coupled in series between node 204 (i.e., the intermediate node of the voltage divider R1, R2) and a node 206 (e.g., resistor RF1 may have a first terminal coupled to node 204 and a second terminal coupled to a node 208, and capacitor CF1 may have a first terminal coupled to node 208 and a second terminal coupled to node 206) to implement frequency compensation, insofar as resistor RF1 and capacitor CF1 introduce a pole at the origin and a zero in the transfer function. In particular, voltage regulator circuit VR may have an anode terminal coupled to ground GND2, a cathode terminal coupled to node 206, and a reference terminal coupled to node 204. In particular, resistor RB2 and light-emitting device L may be coupled in parallel to each other, and as a whole may be coupled in series to resistor RB1 (through which a current IF flows) between the output node 202 and node 206 (e.g., resistor RB2 may have a first terminal coupled to node 206 and a second terminal coupled to a node 210, light-emitting device L may have a cathode terminal coupled to node 206 and an anode terminal coupled to node 210, and resistor RB1 may have a first terminal coupled to node 210 and a second terminal coupled to the output node 202, possibly via the optional circuitry 24). In particular, the optional circuitry 24 may filter the output voltage Vout before passing it to the resistor RB1 at a node 202′ (e.g., resistor RZ may have a first terminal coupled to the output node 202 and a second terminal coupled to node 202′, capacitor CZ may have a first terminal coupled to node 202′ and a second terminal coupled to ground GND2, and Zener diode ZZ—through which a current IZ flows—may be coupled in parallel to capacitor CZ, that is having a cathode terminal coupled to node 202′ and an anode terminal coupled to ground GND2).

The first portion 22a of the feedback loop 20 is coupled to a feedback input node 212 of the control integrated circuit (IC) of the DC-DC converter to provide a feedback signal thereto and may include one or more of the following components: a phototransistor T (or a photodiode); capacitors COPTO (e.g., a parasitic capacitance of the phototransistor T, not to be understood as a discrete component) and CF2; and a resistor RF2; all arranged as exemplified in FIG. 2. The light-emitting device L and the phototransistor T together implement an optocoupler 26 that conventionally has a current transmission ratio CTR of about 0.2 to 0.25 (CTR≈0.2÷0.25), which results in the feedback current IF being about four to five times the control current IC (IF≈4÷5·IC). In particular, the phototransistor T may have an emitter terminal coupled to ground GND1, a collector terminal coupled to a node 214, and a base terminal exposed to receive light generated by the light-emitting device L. In particular, the (parasitic) capacitance COPTO may be arranged between the emitter and collector terminals of the phototransistor T. In particular, the capacitor CF2 may be coupled in parallel to the phototransistor T (e.g., having a first terminal coupled to node 214 and a second terminal coupled to ground GND1). In particular, the resistor RF2—through which a current IC flows—may be coupled in series to the parallel arrangement of phototransistor T and capacitor CF2 (e.g., having a first terminal coupled to node 212 and a second terminal coupled to node 214). It will be noted that the first circuit portion 22a and the second circuit portion 22b are isolated by a galvanic isolation barrier GB, so that the ground terminals GND1 and GND2 are isolated from each other as well. It will also be noted that, as anticipated, the optocoupler 26 may be replace by any other functionally equivalent device based on a different isolation technology.

The SSR approach exemplified in FIG. 2 provides a very accurate regulation of the output voltage Vout (basically depending on the accuracy of the voltage regulator VR and unrelated to the remaining part of the control loop); its drawbacks are the relatively high part count of the overall solution and the optocoupler's aging and sensitivity to external perturbations.

On the other hand, with primary-sensing regulation, the feedback loop of the DC-DC converter is closed by sensing a voltage available on the primary side that is tightly correlated to the output voltage Vout, so that a control signal can be provided to the PWM controller on the primary side with no need of crossing the isolation barrier. A PSR arrangement is exemplified in the circuit diagram of FIG. 3, where a voltage Vaux across an auxiliary winding Naux of the transformer of the DC-DC converter is sensed at the instant when the secondary current is equal to zero, so as to get a relatively accurate image of the output voltage Vout. A voltage signal VZCD (zero-current detection) indicative of voltage Vaux can be passed (e.g., from an intermediate node of a resistive divider RA, RB) to a feedback input 32 of the control IC 30. The control IC 30 may include a knee detector 33, a sample-and-hold circuit 34 producing a sampled signal VSAM, an error amplifier 35 producing a control signal VC, and a current-mode PWM controller 36 arranged as illustrated in FIG. 3, to control the switch SW of the isolated DC-DC converter. The error amplifier 35 may be compensated with the circuit 37 arranged as illustrated in FIG. 3 that realizes a type-2 amplifier. The advantages and drawbacks of the PSR approach may be substantially specular to those of the SSR approach: the reduced bill of materials needs a smaller board space and helps reduce size and cost; besides, not using an optocoupler brings greater safety and reliability. On the other hand, the accuracy of regulation is worse because it is sensitive to the parasitic elements of the power circuit and the inaccuracies of the control circuit, especially during standby conditions.

It is noted that, in some offline power supplies (e.g., for LED drivers, battery chargers, and the like), the output quantity that has to be regulated is the current rather than the voltage. These systems can be seen as controlled current generators. However, in standby conditions the output current, if not zero, is by far lower than the regulated value and this would cause the output voltage to go uncontrolledly high. Therefore, these power supplies also include a voltage regulation loop that takes over when the output voltage exceeds a threshold value (e.g., preset value) because the current demanded by the load is (much) lower than the regulated value. In the end, as far as standby conditions are concerned, reference can be made to output voltage regulation.

Still by way of discussion of concepts relevant to offline power supplies, their operation at very light load or no load (i.e., very small output current or null output current), which occurs in standby conditions, will be described here. As previously mentioned, a common requirement to many applications of switching converters is that conversion efficiency has to be maintained as high as possible also under light load conditions, to comply with regulations and recommendations on energy saving (e.g., EnergyStar, CEC, Eu CoC, Climate Savers, etc.). A known technique for increasing efficiency at light load conditions is to make the switched-mode power supply work in the so-called “burst-mode”. With this operating mode, the converter works intermittently, with a series of switching cycles (bursts) separated by time intervals in which the converter does not switch (idle times). Such behavior is exemplified in the time diagram of FIG. 4, which includes waveforms of the following signals of an isolated (e.g., flyback) DC-DC converter working in burst-mode at light load: feedback signal Vfb, output voltage Vout, flyback drain voltage Vd, and input voltage Vin. When the load is such that the converter has just entered burst-mode operation, the idle times are short; as the load decreases, the duration of the bursts decreases as well and the duration of the idle times increases. In this way, the average switching frequency is considerably reduced and, consequently, so is the effect of switching losses associated to the parasitic elements in the converter, which is the major contributor to power losses at light load. The number of switching cycles in a burst and the idle time are determined by the feedback loop so that the output voltage of the converter always remains under control. Under extremely light load or no load, each burst includes few switching cycles, and the idle time can be even in the range of hundred ms.

### SUMMARY

Despite the developments in the field, there is a need in the art to provide improved isolated DC-DC converters for use in offline power supplies that have reduced power absorption at standby conditions (e.g., so-called “zero-power” power supplies, which have a power consumption of less than 5 mW at standby).

An object of one or more embodiments is to contribute in providing such improved isolated DC-DC converters for use in offline power supplies, corresponding switched-mode power supplies and method of operation.

According to one or more embodiments, such an object can be achieved by controller circuits for an isolated DC-DC converter (e.g., a primary controller IC and a secondary controller IC that are interrelated, insofar as they are configured to work together when assembled on the board of the DC-DC converter), having the features set forth in the claims that follow.

One or more embodiments may relate to a corresponding chipset.

One or more embodiments may relate to a corresponding isolated DC-DC converter.

One or more embodiments may relate to a corresponding switched-mode power supply.

One or more embodiments may relate to a corresponding method of operation.

The claims are an integral part of the technical teaching provided herein in respect of the embodiments.

According to an aspect of the present description, a controller circuit for a primary side of an isolated DC-DC converter includes a first input pin configured for coupling to an anode terminal of a signal receiver of an external isolator to receive a feedback voltage indicative of an output voltage of the isolated DC-DC converter, a second input pin configured to receive a zero-current detection voltage indicative of a voltage across an auxiliary transformer winding of the isolated DC-DC converter, a PWM generator configured to sense the feedback voltage and to produce, based thereon, a PWM control signal for controlling the switching activity of the DC-DC converter, a wake-up pulse detector configured to sense the zero-current detection voltage, a supply voltage generator configured to produce a first supply voltage for the PWM generator and a second supply voltage for the wake-up pulse detector and to source a current to the first input pin, and control circuitry including the wake-up pulse detector. The control circuitry is configured to: in response to the feedback voltage being higher than a first threshold voltage, operate the controller circuit in a first state wherein the supply voltage generator produces the first supply voltage and the second supply voltage, and wherein the PWM generator is enabled; in response to the feedback voltage falling below the first threshold voltage, transition operation of the controller circuit to a second state wherein the supply voltage generator produces the first supply voltage and the second supply voltage, and wherein the PWM generator is disabled; in response to the feedback voltage remaining below the first threshold voltage for a first time interval after transition to the second state, transition operation of the controller circuit to a third state wherein the supply voltage generator does not produce the first supply voltage and produces the second supply voltage and does not source the current to the first input pin, and wherein the PWM generator is disabled; in response to the zero-current detection voltage rising above a second threshold voltage, transition operation of the controller circuit to a fourth state wherein the supply voltage generator produces the first supply voltage and the second supply voltage, and wherein the PWM generator is enabled, and maintain operation of the controller circuit into the fourth state for a second time interval; and in response to the second time interval elapsing after transition to the fourth state, transition operation of the controller circuit to the first state.

According to another aspect of the present description, a controller circuit for a secondary side of an isolated DC-DC converter includes a first input pin configured to receive a feedback voltage indicative of an output voltage of the isolated DC-DC converter, a second input pin configured to receive a secondary-side transformer voltage from a secondary transformer winding of the isolated DC-DC converter, a third input pin configured to receive the output voltage of the isolated DC-DC converter, a first output pin configured for coupling to a cathode terminal of a signal transmitter of an external isolator and to an anode terminal of an external compensation circuit, a second output pin configured for coupling to a cathode terminal of the external compensation circuit, an error amplifier configured to sense the feedback voltage to produce an error signal based on a difference between a reference voltage and the feedback voltage, and to sink a current from the first output pin, a switching detector configured to compare the secondary-side transformer voltage to the output voltage and to detect switching activity of the DC-DC converter based on the secondary-side transformer voltage crossing the output voltage, a wake-up pulse generator configured to sense the feedback voltage, a supply voltage generator configured to produce a first supply voltage for the error amplifier and a second supply voltage for the switching detector and for the wake-up pulse generator, and control circuitry including the switching detector and the wake-up pulse generator. The control circuitry is configured to: in response to switching activity being detected at the second input pin during a detection time interval, operate the controller circuit in a first state wherein the supply voltage generator produces the first supply voltage and the second supply voltage, wherein the error amplifier is enabled to produce the error signal at the first output pin and to sink the current, and wherein the second output pin is connected to ground; in response to switching inactivity being detected at the second input pin during the detection time interval, transition operation of the controller circuit to a second state wherein the supply voltage generator does not produce the first supply voltage and produces the second supply voltage, wherein the error amplifier is disabled and does not sink the current, and wherein the first output pin and the second output pin are floating; in response to the feedback voltage falling below a first threshold voltage while the controller circuit operates in the second state, transition operation of the controller circuit to a third state wherein the wake-up pulse generator produces a wake-up pulse by connecting to ground and subsequently impulsively disconnecting from ground the second input pin or by asserting and subsequently impulsively de-asserting a gate driving signal for a synchronous rectifier of the DC-DC converter; in response to the feedback voltage falling below a second threshold voltage while the controller circuit operates in the first state, transition operation of the controller circuit to the third state; and in response to the wake-up pulse being produced, transition operation of the controller circuit to the first state.

One or more embodiments may thus provide the primary and secondary controllers for a DC-DC converter circuit with a precise SSR feedback loop and very low power consumption at standby.

According to another aspect of the present description, a chipset includes a primary-side controller circuit according to one or more aspects of the preset description and a secondary-side controller circuit according to one or more aspects of the preset description.

According to another aspect of the present description, an isolated DC-DC converter circuit includes a transformer having a primary winding and an auxiliary winding implemented in a primary side of the DC-DC converter, and a secondary winding implemented in a secondary side of the converter, the primary and secondary sides of the converter being isolated by a galvanic isolation barrier, the primary winding being configured to receive a bus DC voltage and being connected in series to a switching transistor, the secondary winding being configured to produce an output DC voltage at an output terminal, and the auxiliary winding being inductively coupled to the secondary winding; a primary-side controller circuit according to one or more aspects of the preset description implemented in the primary side; a secondary-side controller circuit according to one or more aspects of the preset description implemented in the secondary side, an isolator device having a signal transmitter implemented in the secondary side and a signal receiver implemented in the primary side, a first voltage divider coupled in parallel to the auxiliary winding, a second voltage divider coupled between the output node and ground of the secondary side, and a compensation circuit. The first input pin of the primary-side controller circuit is coupled to an anode terminal of the signal receiver, the second input pin of the primary-side controller circuit is coupled to an intermediate node of the first voltage divider, the first input pin of the secondary-side controller circuit is coupled to an intermediate node of the second voltage divider, the second input pin of the secondary-side controller circuit is coupled to the secondary winding, the third input pin of the secondary-side controller circuit is coupled to the output node, the first output pin of the secondary-side controller circuit is coupled to a cathode terminal of the signal transmitter and to an anode terminal of the compensation circuit, and the second output pin of the secondary-side controller circuit is coupled to a cathode terminal of the compensation circuit.

According to another aspect of the present description, a switched-mode power supply includes a pair of input terminals configured to receive an input AC voltage, a rectification stage coupled to the pair of input terminals and configured to rectify the input AC voltage to produce a bus DC voltage, and an isolated DC-DC converter according to one or more aspects of the present description coupled to the rectification stage and configured to regulate the bus DC voltage to produce an output DC voltage, and a pair of output terminals configured for coupling to an electrical load to provide the output DC voltage thereto.

According to another aspect of the present description, a method of operating an isolated DC-DC converter according to one or more aspects of the present description or a switched-mode power supply according to one or more aspects of the present description includes: receiving a primary feedback voltage indicative of an output voltage of the isolated DC-DC converter at the first input pin of the primary-side controller circuit; receiving a zero-current detection voltage indicative of a voltage across the auxiliary winding of the isolated DC-DC converter at the second input pin of the primary-side controller circuit; receiving a secondary feedback voltage indicative of the output voltage of the isolated DC-DC converter at the first input pin of the secondary-side controller circuit; receiving a secondary-side transformer voltage from the secondary winding of the isolated DC-DC converter at the second input pin of the secondary-side controller circuit; receiving the output voltage of the isolated DC-DC converter at the third input pin of the secondary-side controller circuit; in response to the primary feedback voltage being higher than a primary first threshold voltage, operating the primary-side controller circuit in a first state wherein the primary supply voltage generator produces the primary first supply voltage and the primary second supply voltage, and wherein the PWM generator is enabled; in response to the primary feedback voltage falling below the primary first threshold voltage, transitioning operation of the primary-side controller circuit to a second state wherein the primary supply voltage generator produces the primary first supply voltage and the primary second supply voltage, and wherein the PWM generator is disabled; in response to the primary feedback voltage remaining below the primary first threshold voltage for a first time interval after transition to the second state, transitioning operation of the primary-side controller circuit to a third state wherein the primary supply voltage generator does not produce the primary first supply voltage and produces the primary second supply voltage and does not source the current to the first input pin of the primary-side controller circuit, and wherein the PWM generator is disabled; in response to the zero-current detection voltage rising above a primary second threshold voltage, transitioning operation of the primary-side controller circuit to a fourth state wherein the primary supply voltage generator produces the primary first supply voltage and the primary second supply voltage, and wherein the PWM generator is enabled, and maintaining operation of the primary-side controller circuit into the fourth state for a second time interval; in response to the second time interval elapsing after transition to the fourth state, transitioning operation of the primary-side controller circuit to the first state; in response to switching activity being detected at the second input pin of the secondary-side controller circuit during a detection time interval, operating the secondary-side controller circuit in a first state wherein the secondary supply voltage generator produces the secondary first supply voltage and the secondary second supply voltage, wherein the error amplifier is enabled to produce the error signal at the first output pin of the secondary-side controller circuit and to sink the current, and wherein the second output pin of the secondary-side controller circuit is connected to ground of the secondary side; in response to switching inactivity being detected at the second input pin of the secondary-side controller circuit during the detection time interval, transitioning operation of the secondary-side controller circuit to a second state wherein the secondary supply voltage generator does not produce the secondary first supply voltage and produces the secondary second supply voltage, wherein the error amplifier is disabled and does not sink the current, and wherein the first output pin and the second output pin of the secondary-side controller circuit are floating; in response to the secondary feedback voltage falling below a secondary first threshold voltage while the secondary-side controller circuit operates in the second state, transitioning operation of the secondary-side controller circuit to a third state wherein the wake-up pulse generator produces a wake-up pulse by connecting to ground and subsequently impulsively disconnecting from ground the second input pin of the secondary-side controller circuit or by asserting and subsequently impulsively de-asserting a gate driving signal for a synchronous rectifier of the DC-DC converter; in response to the secondary feedback voltage falling below a secondary second threshold voltage while the secondary-side controller circuit operates in the first state, transitioning operation of the secondary-side controller circuit to the third state; and in response to the wake-up pulse being produced, transitioning operation of the secondary-side controller circuit to the first state.

### BRIEF DESCRIPTION OF THE DRAWINGS

One or more embodiments will now be described, by way of example only, with reference to the annexed figures, wherein:

FIG. 1 is a circuit block diagram exemplary of a conventional offline power supply;

FIG. 2 is a circuit diagram exemplary of a secondary-sensing regulation (SSR) feedback loop of a conventional DC-DC converter;

FIG. 3 is a circuit diagram exemplary of a conventional offline power supply including a DC-DC converter having a primary-sensing regulation (PSR) feedback loop;

FIG. 4 is a time diagram exemplary of waveforms of signals in a conventional isolated DC-DC converter working in burst-mode at light load;

FIG. 5 is a circuit block diagram exemplary of an offline power supply including a PSR system able to achieve an input power of less than 5 mW at no load;

FIGS. 6A and 6B are time diagrams exemplary of waveforms of signals in the offline power supply of FIG. 5, at different time scales;

FIG. 7 is a state diagram exemplary of operation of two state machines implemented respectively in the primary controller and the secondary controller of a DC-DC converter (e.g., for use in an offline power supply) according to one or more embodiments of the present description;

FIGS. 8A, 8B and 8C are circuit diagrams exemplary of three common configurations of secondary rectification that may be implemented in a flyback converter;

FIG. 9 is a circuit diagram exemplary of a possible implementation of a primary controller for an SSR-based DC-DC converter (e.g., for an offline power supply), implementing the left portion of the state machine of FIG. 7, according to one or more embodiments of the present description;

FIG. 10 is a circuit diagram exemplary of a possible implementation of a secondary controller for an SSR-based DC-DC converter (e.g., for an offline power supply), implementing the right portion of the state machine of FIG. 7, configured to generate a wake-up pulse via an internal switch, according to one or more embodiments of the present description;

FIG. 11 is a circuit diagram exemplary of another possible implementation of a secondary controller for an SSR-based DC-DC converter (e.g., for an offline power supply), implementing the right portion of the state machine of FIG. 7, configured to generate a wake-up pulse by controlling an external synchronous rectifier transistor, according to one or more embodiments of the present description;

FIG. 12 is a time diagram exemplary of simulated waveforms of signals in an AC-DC charger according to one or more embodiments of the present description, showing a single burst of switching cycles; and

FIG. 13 is a time diagram exemplary of simulated waveforms of signals in an AC-DC charger on a much longer time frame than FIG. 12.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

As anticipated, an object of one or more embodiments of the present description is that of providing an improved DC-DC converter for use in an offline power supply (e.g., a switched-mode power supply) that has reduced power absorption at standby conditions (ideally, attaining the “zero-power” classification, meaning that power consumption is less than 5 mW at standby).

In order to do so, the obstacles that prevent a switching converter working in burst-mode from achieving an extremely low consumption and meeting the zero-standby power target have to be considered. Depending on whether secondary-sensing regulation (SSR) or primary-sensing regulation (PSR) is used, the situation may be different.

If an SSR architecture is used, the energy saving functions conventionally included in the PWM controllers used in AC-DC converters may not be sufficient to achieve the zero-standby power target (e.g., the documented best result is a power absorption of about 8 mW with no load). The consumption of the output voltage monitoring circuit on the secondary side (e.g., voltage divider R1, R2), the consumption of the circuit that transfers the feedback signal from the secondary side to the primary side through the isolation barrier (e.g., optocoupler 26 or another functionally equivalent device), and the consumption of the PWM controller on the primary side are the major responsible for this inability.

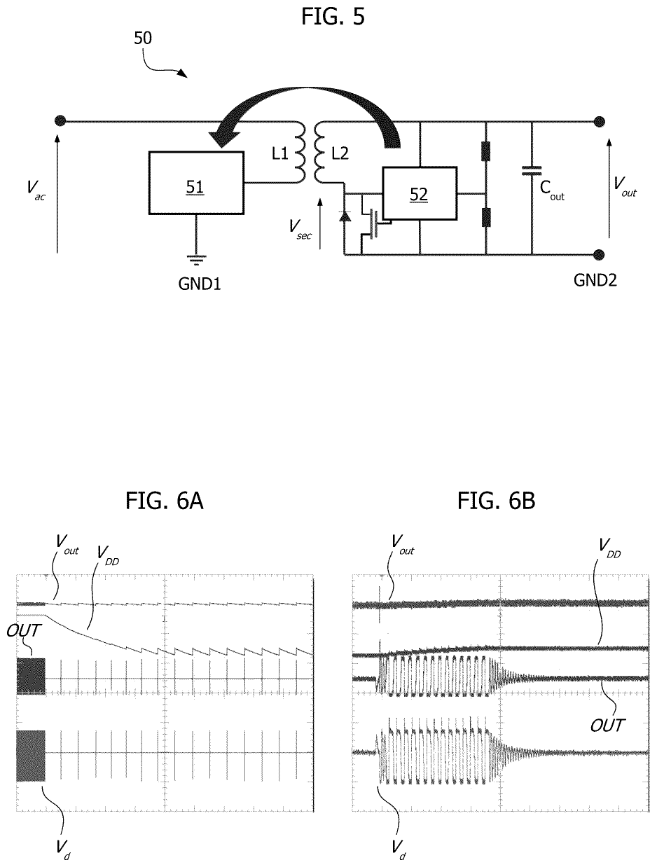

If a PSR architecture and a chipset approach is used (e.g., a PWM controller implemented in the primary side and a wake-up controller implemented in the secondary side), these consumptions can be minimized or almost eliminated at all, so that power absorption of less than 5 mW can be achieved if the converter's load during standby conditions is limited to no more than 1 mW (the system designer is responsible for minimizing this standby load). This possibility is proven in the systems disclosed in U.S. Pat. Nos. 9,595,861 B2, 9,787,192 B2, and 9,812,972 B2 assigned to companies of the STMicroelectronics group, which are all incorporated herein by reference in their entirety. FIG. 5 is a circuit block diagram exemplary of such a PSR system able to achieve an input power of less than 5 mW at no load. The AC-DC converter 50 includes a PWM controller 51 (e.g., an application-specific integrated circuit, ASIC) coupled to the primary winding L1 of the transformer in the primary side, and a wake-up controller circuit 52 coupled to the secondary winding L2 of the transformer in the secondary side. The wake-up controller 52 monitors the output voltage Vout during burst-mode while the PWM controller 51 is idle and almost completely shut down. The secondary-to-primary communication occurs through the transformer: when voltage Vout falls below a threshold value (e.g., predetermined), a wake-up pulse is generated by turning on an internal switch SW1 that connects the output capacitor Cout to the secondary winding L2 for a short while. The controller 51 on the primary side detects the pulse via an auxiliary winding (not visible in FIG. 5), wakes up all the internal circuits and starts a burst of switching cycles. Such behavior is exemplified in the time diagrams of FIGS. 6A and 6B, which include waveforms of the following signals of the PSR power supply of FIG. 5: output voltage Vout, supply voltage of the PWM controller VDD, wake-up signal OUT, flyback drain voltage Vd. Specifically, both diagrams relate to a prototype power supply rated for 15 W output power. The diagram of FIG. 6A relates to a 230 V input alternating voltage, and the measurements result in a 3.3 mW no-load input power consumption. The diagram of FIG. 6B shows a zoomed image of a single burst of switching cycles.

Therefore, PSR is a viable method to achieve a standby power absorption lower than 5 mW, but is by nature less accurate and precise than SSR, so in the industry there is the demand for an SSR solution able to achieve the “zero-power” target like a PSR solution. It is thus desirable to develop an isolated DC-DC converter (e.g., for a power supply) with an SSR architecture, having a standby power consumption comparable to the standby power consumption of PSR architectures. More specifically, reduction of the standby power consumption in a power supply with SSR architecture (down to the “zero-power” target as previously discussed) may be addressed by improving on one or more of the following points: (i) reducing (e.g., minimizing) the current consumption of the output voltage monitoring circuit (e.g., the current IR that flows through the resistive voltage divider R1, R2 exemplified in FIG. 2); (ii) reducing (e.g., zeroing) the current IF that flows through the light-emitting diode of the optocoupler 26 (e.g., LED L exemplified in FIG. 2) or through a functionally equivalent isolator while the converter is idle; and (iii) reducing (e.g., zeroing) the control current IC that flows through the phototransistor of the optocoupler 26 (e.g., phototransistor T exemplified in FIG. 2) or through a functionally equivalent isolator while the converter is idle.

The present disclosure will thus describe in detail a switched-mode power supply with an SSR architecture (e.g., a feedback loop similar to that previously described with reference to FIG. 2), and a related method, which improve on one or more of the three consumption sources listed above. It will be understood that other power-saving provisions known in the art to minimize the quiescent consumption on both the primary and the secondary control ICs (like in the PSR architecture) can be used in combination with the new architecture and method that will be discussed in the present description (e.g., shutting down all the functional blocks except those needed to restart a burst, such as the output voltage monitoring in the secondary side IC, and the wake-up pulse detector in the primary side IC). A reasonable target is to achieve a quiescent current Iq of less than 50 μA on both.

Also, it will be noted that the chipset and method here disclosed are applicable in principle to any power conversion (DC-DC) topology. However, the “zero standby power” target is usually aimed at in power supplies rated for an output power of a few ten watts. In that power range, the flyback converter topology is mostly used. Therefore, for the sake of clarity of the present description, reference will be made, more or less explicitly, to the flyback topology.

The control method proposed herein, which aims at reducing (virtually down to zero) the currents IR, IF and IC as previously discussed, may be implemented with two interacting (e.g., interrelated) state machines, one for the primary controller (also referred to as primary-side state machine, PSSM) and one for the secondary controller (also referred to as secondary-side state machine, SSSM) of the DC-DC converter implemented in the offline power supply.

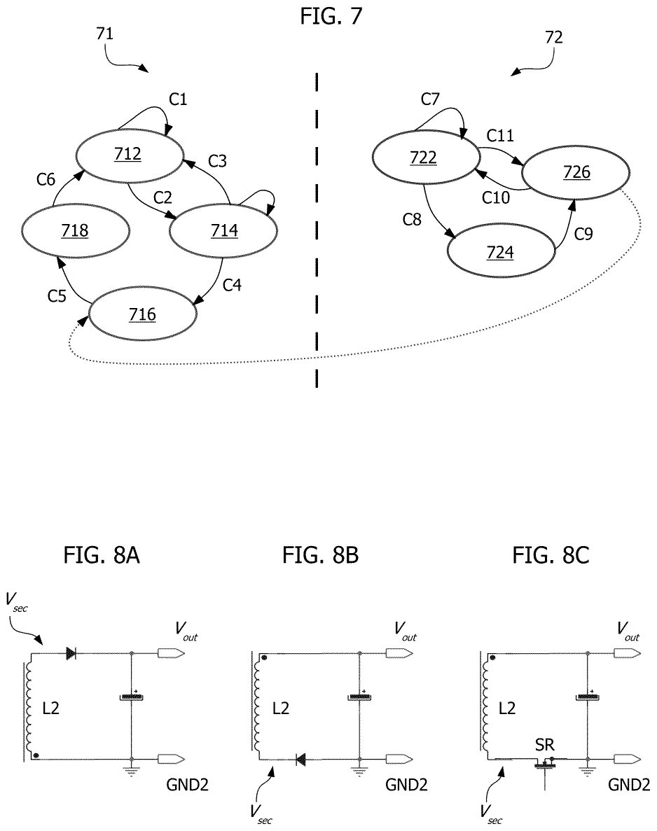

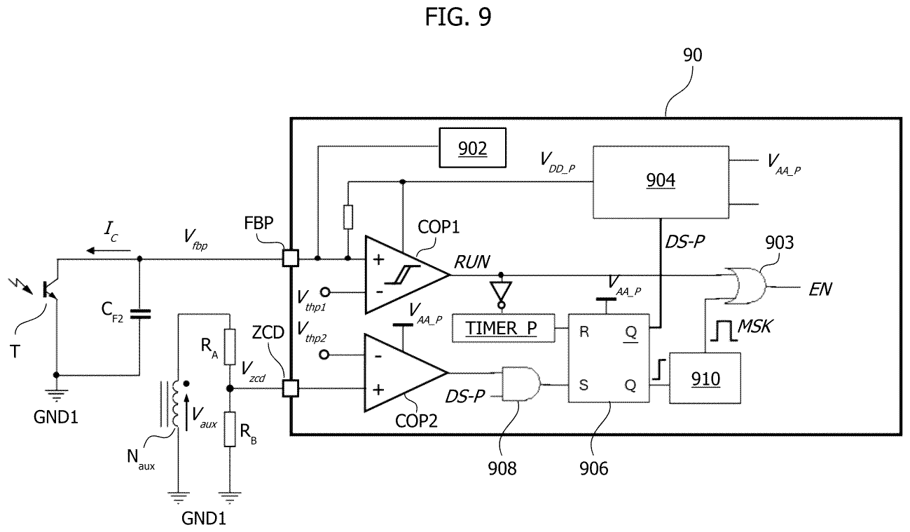

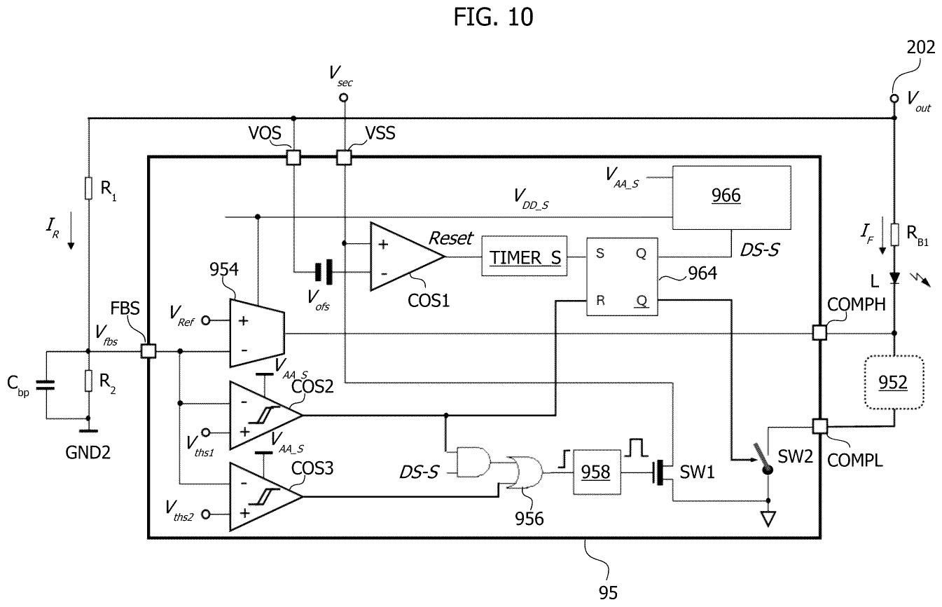

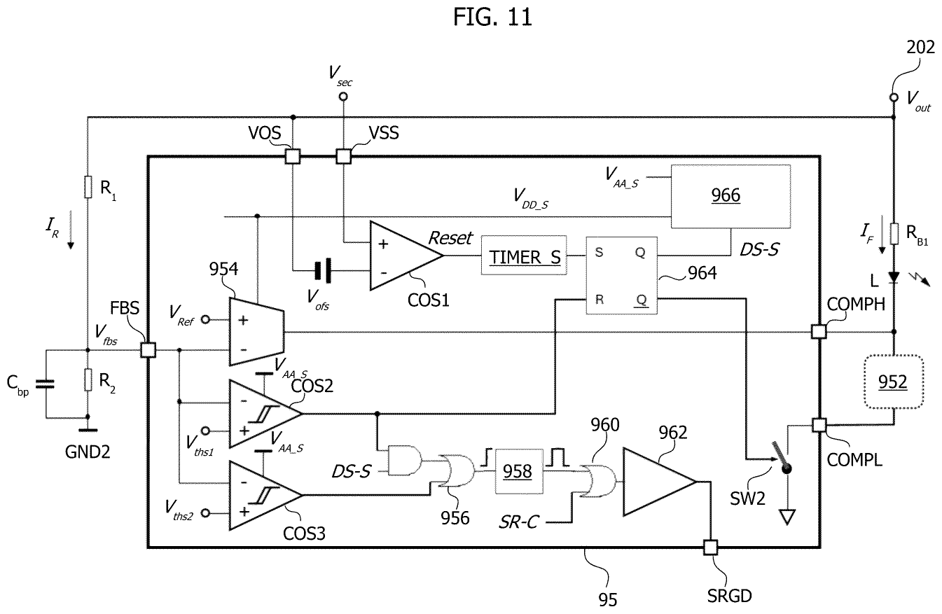

Operation of such state machines may be described by making reference to the state diagrams exemplified in FIG. 7. A possible circuit implementation 90 of the primary-side state machine (e.g., a primary controller) is illustrated in the circuit diagram of FIG. 9. Possible circuit implementations 95 of the secondary-side state machine (e.g., secondary controllers) are illustrated in the circuit diagrams of FIGS. 10 and 11. In the following, operation of the PSSM and the SSSM will be described first (by making reference to FIG. 7), and their possible structures will be described later (by making reference to FIGS. 9, 10 and 11).

The main functional blocks of the PSSM 71 are a first resettable timer (also referred to as TIMER_P), a wake-up pulse detector (also referred to as WUPD), a pair of comparators with hysteresis (also referred to as COP1 and COP2), and two reference (or threshold) voltages Vthp1, Vthp2. One of the comparators may be part of the wake-up pulse detector, as described more in detail in the following. Furthermore, two electrical quantities are used for the operation of the PSSM 71. In particular, these quantities include the control voltage Vfbp of the feedback loop of the DC-DC converter (that is, the control signal transmitted from the secondary side 22b by the optocoupler 26 or equivalent device through the isolation barrier GB—refer again to FIG. 2), and (a partition of) the voltage Vaux across the auxiliary winding Naux of the transformer—the same used to supply the controller. Both quantities may be accessed through dedicated pins of the primary-side controller.

In order to explain operation of the PSSM 71, consider initially a loading condition for the DC-DC converter such that the DC-DC converter is continuously switching. This will be referred to as the “RUN” state (indicated as state 712 in FIG. 7), which represents the normal operating condition in a large load range where the load is quite substantial (e.g., from 10% to 100% of the rated load) and is characterized by a level of the control voltage Vfbp greater than a (preset) threshold voltage Vthp1. Therefore, as long as the condition Vfbp≥Vthp1 (condition C1 in FIG. 7) is verified, the PSSM 71 remains in the RUN state 712. While in the state 712, the first timer (TIMER_P) is kept reset at zero.

Now, consider a reduction of the output load (either progressive or step-change) such that the control voltage Vfbp falls below the threshold voltage Vthp1 (i.e., Vfbp<Vthp1, condition C2 in FIG. 7). As a result, the PSSM 71 moves to the “IDLE” state (indicated as state 714 in FIG. 7), where the switching activity of the DC-DC converter is disabled and the first timer (TIMER_P) starts counting. All the other functional blocks of the primary-side controller may be normally supplied like in the “RUN” state 712.

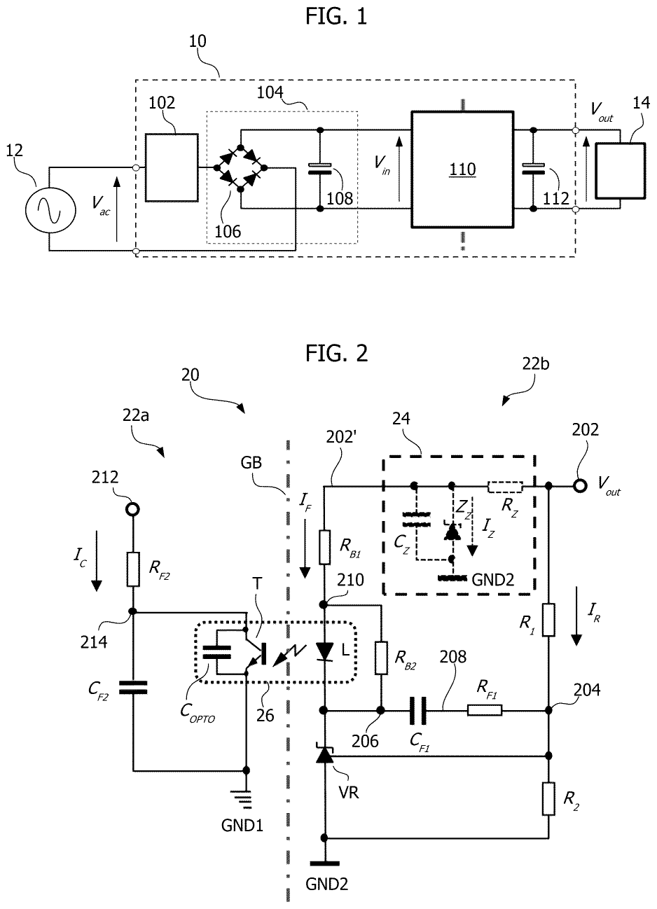

Since no energy is delivered to the output of the DC-DC converter in the “IDLE” state 714, the load 14 is supplied only by the output capacitor bank 112 (refer again to FIG. 1), and the output voltage Vout starts decaying. The feedback loop reacts by increasing the control voltage Vfbp at a speed that depends on the decay rate of the output voltage Vout (e.g., the faster Vout decays, the faster Vfbp rises, and vice versa), in order to try to restore the expected (regulated) value of the output voltage Vout.

If, while in the “IDLE” state 714, the load is such that the voltage Vfbp exceeds the threshold voltage Vthp1 (possibly considering the hysteresis Hys1 of the first comparator COP1) before the first timer reaches its end-of-count, EOC (i.e., Vfbp>Vthp1+Hys1, condition C3 in FIG. 7), the PSSM 71 moves back to the “RUN” state 712. In this state, the DC-DC converter restarts switching and the first timer is reset again at zero. If the load in the meantime does not change significantly, the PSSM 71 will go back and forth between the “RUN” state 712 and the “IDLE” state 714 (alternating conditions C2 and C3 based on the comparison of the feedback voltage Vfbp with the first threshold voltage Vthp1).

If instead, while in the “IDLE” state 714, the load is so low that the first timer reaches its end-of-count before the voltage Vfbp exceeds the value Vthp1+Hys1 (condition C4 in FIG. 7), the PSSM 71 moves to the “SLEEP” state 716, where switching of the DC-DC converter is kept disabled and, in addition, all the internal blocks of the primary-side controller are shut down (or no longer supplied), except the wake-up pulse detector, which has to remain active in order to make the PSSM 71 exit from the “SLEEP” state 716 and restart switching, as further described in the following. The current consumption of the wake-up pulse detector may be as low as possible, insofar as this block remains always active. It will be noted that when the PSSM 71 operates in the “SLEEP” state 716, the control voltage Vfbp decreases to zero because the internal circuits that provide the current IC sunk by the phototransistor T are shut down. Therefore, the current IC is substantially null in the “SLEEP” state 716.

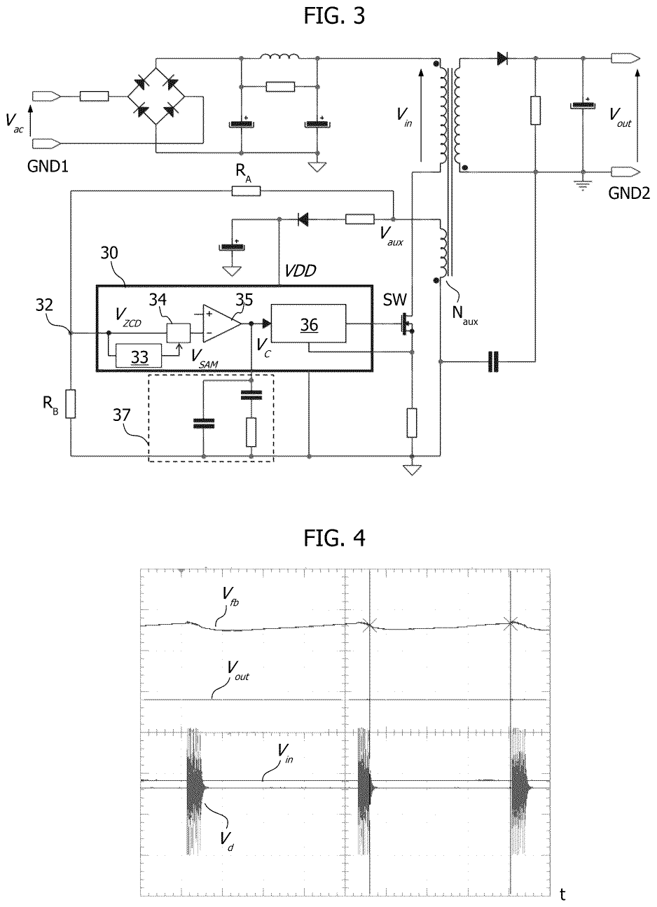

The wake-up pulse detector may include the second comparator and the threshold voltage Vthp2. As discussed in U.S. Pat. No. 9,595,861 B2 assigned to companies of the STMicroelectronics group, the wake-up pulse generated by the secondary controller appears as a glitch on the voltage Vaux across the auxiliary winding Naux of the transformer, which is also used for supplying the primary controller IC (refer again to FIG. 3) and, in some cases, for other purposes too. While the DC-DC converter is not switching (as in the “SLEEP” state 716), the voltage Vaux is null, so that a wake-up pulse can be easily detected by comparing voltage Vaux (or a portion thereof, obtained via a voltage divider) with a slightly positive threshold voltage Vthp2 in the second comparator (COP2).

When this second comparator is triggered by the voltage Vaux being higher than the second threshold voltage Vthp2 (i.e., Vaux>Vthp2, condition C5 in FIG. 7), the PSSM 71 exits from the “SLEEP” state 716 and transitions to the “RUN-OL” state 718. In this state, all the blocks of the controller that were previously disabled are powered again, and the DC-DC converter restarts switching. The PSSM 71 stays in the “RUN-OL” state 718 for a (e.g., prefixed) amount of time TMSK, in order to let the control loop close again and let the control voltage Vfbp exceed the value Vthp1+Hys1 so as to prevent an immediate transition to the “IDLE” state 714. Therefore, upon expiry of the time interval TMSK (condition C6 in FIG. 7), the PSSM 71 transitions again to the “RUN” state 712. Therefore, substantially, operation of the DC-DC converter in the “RUN” state 712 and in the “RUN-OL” state 718 is the same, except that in the “RUN” state 712 the switching activity is controlled based on the comparison of the feedback signal Vfbp to the first threshold voltage Vthp1, while in the “RUN-OL” state 718 the switching activity is forced to take place for a fixed amount of time TMSK independently from the value of the feedback signal Vfbp, in order to let the feedback signal Vfbp stabilize after exiting from a “SLEEP” state 716.

Turning now to the operation of the secondary-side state machine 72, the main functional blocks of the SSSM 72 are a transconductance-type error amplifier (also referred to as TTEA), a second resettable timer (also referred to as TIMER_S), an output voltage monitoring system (also referred to as VM), a wake-up pulse generator (also referred to as WUPG), a set of comparators with hysteresis (also referred to as COS1, COS2 and COS3), and two reference (or threshold) voltages Vths1, Vths2. One of the comparators may be part of the output voltage monitoring system. Furthermore, two electrical quantities are used for the operation of the SSSM 72. In particular, these quantities include a partition Vfbs of the output voltage Vout and (a partition of) the voltage Vsec across the secondary winding of the transformer. Voltage Vfbs may be brought to the inverting input of the transconductance-type error amplifier and to the output voltage monitoring system via an (external) resistor divider. The values of these resistors may be large enough to minimize the current IR flowing through the voltage monitoring circuit. Voltage Vfbs is proportional to the output voltage Vout: in fact, with a transconductance type operational amplifier the frequency compensation network can be connected between the output of the operational amplifier and ground, leaving the inverting input uncommitted. Voltage Vsec may be brought to a dedicated pin of the secondary-side controller as well.

In order to explain operation of the SSSM 72, consider initially a loading condition for the DC-DC converter such that the DC-DC converter is continuously switching. This will be referred to as the “RUN” state (indicated as state 722 in FIG. 7), and substantially corresponds to the “RUN” state 712 of the PSSM 71, where the DC-DC converter is switching continuously and all the functional blocks are up and running. The continuous switching state of the DC-DC converter can be detected by sensing voltage Vsec at the secondary winding L2 of the transformer: if the DC-DC converter is switching, voltage Vsec is continuously going up and down; if the DC-DC converter is not switching (i.e., during idle times), voltage Vsec is equal to either zero or voltage Vout, depending on the secondary rectification configuration. In this regard, reference can be made to FIGS. 8A, 8B and 8C. If the configuration of the secondary rectification is the one exemplified in FIG. 8A, then during the idle times Vsec=0. Otherwise, if the configuration of the secondary rectification is the one exemplified in FIG. 8B or in FIG. 8C, then during the idle times Vsec=Vout. Therefore, whether the DC-DC converter is switching or not can be detected by comparing the voltage Vsec across the secondary winding to an appropriate fixed value (threshold) using a first comparator (COS1). If there is switching activity of the DC-DC converter, the output of the first comparator will produce a square wave, otherwise if there is no switching activity of the DC-DC converter, the output of the first comparator will be at a fixed state (either high or low).

The second timer (TIMER_S) is operated by the output state of the first comparator (COS1): in one state the second timer is counting, in the other state it is reset at zero. When there is no switching of the DC-DC converter, the output of the first comparator is such that the second timer is counting, while during continuous switching of the DC-DC converter the square wave produced by the first comparator (COS1) will continuously reset the second timer. In this way, the second timer measures the duration of the idle periods of the DC-DC converter and its end-of-count (EOC) can be reached only if the duration of the idle period exceeds a (preset) threshold value. For reasons that will be further discussed in the following, the end-of-count of the second timer (TIMER_S, implemented in the secondary side of the converter) is higher than the end-of-count of the first timer (TIMER_P, implemented in the primary side of the converter). In particular, considering that the two timers are located in different devices, and that both have their own tolerances, the two durations are uncorrelated, thus more specifically the design requirement may be that the minimum end-of-count of the second timer (TIMER_S) is higher than the maximum end-of-count of the first timer (TIMER_P). If switching activity of the DC-DC converter is detected before the second timer (TIMER_S) reaches its end-of-count (condition C7 in FIG. 7), this means that the primary side has not gone into the “SLEEP” state 716, and the SSSM 72 stays in its “RUN” state 722.

If the idle period of the DC-DC converter lasts long enough to make the PSSM 71 enter the “SLEEP” state 716, no switching can occur until the secondary controller emits a wake-up pulse, therefore the second timer (TIMER_S) will reach its own end-of-count (condition C8 in FIG. 7) soon after and also the SSSM 72 will go into its own “SLEEP” state 724, to minimize the consumption associated to the secondary control.

In one or more embodiments, the wake-up pulse is generated while the DC-DC converter is not switching. This is because in a flyback converter a simultaneous turn-on of the primary switch and the switch that generates the wake-up pulse may cause a dangerous overcurrent situation like a saturated transformer, which better be avoided. To do so, the wake-up pulse may be generated when the PSSM 71 is definitely in the “SLEEP” state 716. This is why the end-of-count of the second timer (TIMER_S) is greater than the end-of-count of the first timer (TIMER_P).

While the SSSM 72 is in its “SLEEP” state 724, all the internal blocks are shut down (or no longer supplied), except the output voltage monitor and the wake-up pulse generator, whose current consumption is preferably as low as possible. Noticeably, in the “SLEEP” state 724 the circuit that supplies the current IF to the light-emitting device L of the optocoupler 26 is open, in order to nullify the current IF.

The transition from the “SLEEP” state 724 to the “RUN2” state 726 occurs when the output voltage Vout falls below a (predetermined) threshold value, which is revealed by the second comparator (COS2) as the voltage Vfbs falls below the threshold voltage Vths1 (Vfbs<Vths1, condition C9 in FIG. 7). Operation in the “RUN2” state 726 causes the wake-up pulse generator to issue the wake-up pulse, and subsequently transition to the “RUN” state 722 in response to the wake-up pulse having being issued (condition C10 in FIG. 7).

Now, starting from the “RUN” state 722 of the SSSM 72, let's consider the case when the PSSM 71 has gone into its “SLEEP” state 716 (so there is no switching activity of the DC-DC converter, and the PSSM 71 is waiting for the wake-up pulse to come) but the second timer (TIMER_S) has not reached yet its end-of-count (so, condition C8 is not satisfied). If in this time interval the load is applied to the DC-DC converter, the switching activity has to be restarted immediately. To do so, if the third comparator (COS3) detects that the voltage Vfbs falls below the second threshold voltage Vths2 which is lower than Vths1 (i.e., Vfbs<Vths2, condition C11 in FIG. 7), the SSSM 72 transitions to the “RUN2” state 726, the wake-up pulse generator issues a wake-up pulse, and then the SSSM 72 transitions to the “RUN” state 722 immediately after (condition C10 in FIG. 7). It will be noted that using a second threshold voltage Vths2 lower than Vths1, which is active while the SSSM machine 72 is in the “RUN” state 722, allows the use of a threshold voltage Vths1 (active only during the “SLEEP” state 724) that is very close to the reference value of the feedback loop, with no risk of transitioning accidentally into the “RUN2” state 726 and emitting a wake-up pulse while the converter is switching.

As anticipated, an exemplary implementation of a primary controller 90 that, in addition to the PWM control, embodies the PSSM 71 just described is shown in the circuit block diagram of FIG. 9. The primary controller 90 has two input pins to sense the electrical quantities that are used to carry out the control algorithm described above. A first input pin FBP of the controller 90 senses the control signal Vfbp transmitted from the secondary side 22b by the optocoupler 26 (or equivalent device) through the isolation barrier GB. Typically, the current IC (e.g., sunk by the phototransistor T) modulates the voltage Vfbp at the pin FBP, which therefore represents the control variable. The voltage Vfbp is passed to a PWM generation block 902, in most cases determining the peak primary current and thus determining the amount of energy taken from the input source and to be steered to the output load at each switching cycle. Normally, the higher the voltage Vfbp, the larger the power demanded by the load. In this context, voltage Vfbp is sensed to determine when the load level is low enough to enter burst-mode operation. A second input pin ZCD of the controller 90 senses a voltage Vzcd that is a partition of the voltage Vaux across the auxiliary winding Naux of the power transformer, the same winding that is normally used to power the control IC. The voltage Vzcd can be used for many different purposes. In this context, it is used to detect the wake-up pulse that is generated by the secondary-side controller to restart switching after a long idle period during burst-mode operation.

The input pin FBP is coupled (e.g., connected) internally to a first (e.g., non-inverting) input of a first comparator COP1, which receives the threshold voltage Vthp1 at a second (e.g., inverting) input. The output of comparator COP1, that is signal RUN, is asserted (e.g., high) when Vfbp>Vthp1+Hys1. Assertion of signal RUN corresponds to the “RUN” state 712 of the PSSM 71, and enables the PWM generator 902 insofar as the enable signal EN for the PWM generator 902 is produced at the output of an OR logic gate 903 that receives signal RUN at one of its input terminals. The output of comparator COP1, that is signal RUN, disables the PWM generator 902 when it is de-asserted (e.g., low), that is, when Vfbp<Vthp1, corresponding to the “IDLE” state 714 of the PSSM 71. The signal RUN is also passed to the first timer TIMER_P via a NOT gate (inverter) as an active-low reset signal (or as an enable signal), so that the first timer TIMER_P is disabled when signal RUN is asserted (e.g., high) and is enabled when signal RUN is de-asserted (e.g., low).

The current IC sunk by the phototransistor T (external to the primary controller 90) comes from a supply voltage generator 904 of the primary controller 90 (see, in FIG. 9, the connection from an output of the supply voltage generator 904 to pin FBP via a current-limiting resistor), which also provides a first supply voltage VDD_P to some of the functional blocks of the primary controller 90 (see, in FIG. 9, the connection from an output of the supply voltage generator 904 to the supply pin of comparator COP1; the generator 904 may also provide the first supply voltage VDD_P to the PWM generator 902). In addition, the supply voltage generator 904 provides a second supply voltage VAA_P to other functional blocks of the primary controller 90, such as a second comparator COP2, an AND gate 908 and a S-R flip flop 906. A deep sleep signal DS-P is produced at the complemented data output Q of the set-reset (SR) flip-flop 906 and controls the supply voltage generator 904. When the deep sleep signal DS-P is asserted (e.g., high), it disables the supply voltage VDD_P produced by the generator 904, cutting power to all blocks, except the rail voltage VAA_P that supplies the second comparator COP2 as well as the AND gate 908 and the S-R flip flop 906. Comparator COP2, AND gate 908 and flip flop 906 make up the wake-up pulse detector. The reset input of the S-R flip-flop 906 is coupled to the output of the timer TIMER_P so that the flip-flop 906 is reset (thus disabling the voltage VDD_P from the supply voltage generator 904) when the timer TIMER_P reaches its end-of-count (condition C4 in FIG. 7, and transition to the “SLEEP” state 716 of the PSSM 71). The set input of the S-R flip-flop 906 is coupled to the output terminal of the AND logic gate 908, which in turn receives the output from the second comparator COP2 and the sleep signal DS-P at its input terminals, so that the flip-flop 906 is set while it is in the reset state (i.e., when signal DS-P is asserted) when the output of the comparator COP2 gets asserted (e.g., high), which happens if voltage Vzcd experiences a rising edge exceeding the threshold voltage Vthp2 (since the non-inverting input terminal of comparator COP 2 is coupled to pin ZCD, and the inverting input terminal of comparator COP2 is configured to receive the threshold voltage Vthp2), which corresponds to a wake-up pulse. In response to the flip-flop 906 being set, its data output Q gets asserted (e.g., high) and makes a monostable flip-flop 910 release a pulse signal MSK having a duration TMSK (e.g., in the range of few ten of μs) that is received at a second input of the OR gate 903 and forces the output of the OR gate 903 (i.e., the PWM enable signal EN) to an asserted (e.g., high) state, thus enabling the PWM generator 902 and restarting switching of the DC-DC converter (condition C5 in FIG. 7, and transition to the “RUN-OL” state 718 of the PSSM 71). The time interval TMSK during which the enable signal EN is forced to an asserted state by the monostable flip-flop 910 prevents the PWM enable signal EN from staying low or temporarily going low during the time needed for the output of first comparator COP1 (i.e., signal RUN) to go high after the input pin FBP and the comparator COP1 are powered again. It will be noted that if signal RUN stays low for a time duration insufficient for the timer TIMER_P to reach its end-of-count (i.e., if Vfbp>Vthp1+Hys1 before the timer TIMER_P reaches its end-of-count), the PWM generator 902 remains powered, though disabled, switching of the DC-DC converter is restarted immediately, and the timer TIMER_P is reset at zero (condition C3 in FIG. 7, and transition from the “IDLE” state 714 to the “RUN” state 712 of the PSSM 71).

As anticipated, exemplary implementations of a secondary controller 95 that, in addition to the secondary-sensing regulation (SSR), embeds the SSSM 72 just described are shown in the circuit block diagrams of FIGS. 10 and 11.

In particular, the embodiment of FIG. 10 may be suitable in case the configuration of the secondary rectification of the DC-DC converter is the one exemplified in FIG. 8B or in FIG. 8C. In case the architecture of FIG. 8C is used, the secondary controller 95 may also implement control of the synchronous rectifier (i.e., the transistor coupled between ground and the secondary winding L2 of the transformer). The secondary controller 95 has five input or output pins to sense the electrical quantities that are used to carry out the control algorithm described above. A first input pin FBS of the secondary controller 95 senses the voltage Vfbs that is indicative of the output voltage Vout, e.g., via a voltage divider R1, R2 (refer also to FIG. 2) properly set to obtain the specified output voltage Vout (insofar as, in closed loop operation, essentially Vfbs=VRef and thus Vout=VRef. (1+R1/R2)). Since the resistance values of resistors R1 and R2 may be quite high to minimize the associated current consumption (i.e., minimize current IR as targeted), a small bypass capacitor Cbp may be connected externally between the pin FBS and ground GND2 to filter out undesired switching noise. Pin FBS is the input of the output voltage monitoring system of the secondary controller 95. A second input pin VOS of the secondary controller 95 is directly connected to the output bus 202 to receive the output voltage Vout and, along with a third input pin VSS, is an input of the switching activity detection block. The third input pin VSS of the secondary controller 95 is directly connected to the secondary winding L2 of the transformer to receive the secondary voltage Vsec. During switching of the DC-DC converter, voltage Vsec swings from nearly zero to a value equal to Vout+Vin/n (where Vin is the input voltage to the DC-DC converter and n is the primary-to-secondary turns ratio of the power transformer). While the DC-DC converter is idle (not switching), voltage Vsec tracks (follows) voltage Vout. The wake-up pulse is generated through pin VSS. If the secondary controller 95 embeds the control of the synchronous rectifier (in the case of use of the rectification architecture of FIG. 8C), the voltage Vsec received at pin VSS may be used also to carry out this function. A fourth pin COMPH of the secondary controller 95 is externally connected to the cathode of the light-emitting device L (whose anode is connected to the output pin 202, e.g., via a limiting resistor RB1—reference can be made again to FIG. 2 as well) and to a first (e.g., anode) terminal of an external compensation network 952 (e.g., RC network) that carries out frequency compensation of the voltage regulation loop. Internally, pin COMPH is connected to the output of an error amplifier 954 and is floating when the SSSM 72 is in “SLEEP” state 724. A fifth pin COMPL of the secondary controller 95 is externally connected to the second (e.g., cathode) terminal of the compensation network 952 and is internally selectively couplable to ground via a switch SW2. In particular, switch SW2 is closed (and pin COMPL is internally grounded) during normal operation (that is, when the SSSM 72 is in the “RUN” state 722), whereas switch SW2 is open (and pin COMPL is floating) when the SSSM 72 is in the “SLEEP” state 724. Having both pins COMPH and COMPL internally floating in the “SLEEP” state 724 allows for the current IF through the light-emitting device L to be minimized (e.g., reduced to zero) as targeted, and freezes the conditions of the compensation network 952, so that when switching of the DC-DC converter restarts the value of the commanded peak current will be close to the last value just prior to stopping.

In the secondary controller 95, the voltage Vfbs is passed from pin FBS to the inverting input of a transconductance-type error amplifier 954 (OTA), whose non-inverting input is configured to receive the reference voltage VRef of the output voltage regulation loop. The transconductance (gm) of the amplifier 954 may be, for instance, in the range of ten mS. The error amplifier 954 may have an open drain (or open collector) output, so that it may only sink current that is externally available from pin COMPH. The current sunk by the amplifier 954, which is proportional to the difference between voltage Vfbs and voltage VRef, determines the current IF that flows through the light-emitting device L along with the current that flows through the external RC network 952. With such an arrangement, in closed-loop operation voltage Vfbs is a few mV above voltage VRef, so the output voltage Vout will be slightly higher than the expected value VRef*(1+R1/R2) but, considering that the current IF is typically in the range of hundred μA, the difference will be in the range of ten mV, well within acceptable limits. The external RC network 952 connected between pins COMPH and COMPL facilitates proper shaping of the control-to-output transfer function (frequency compensation). With the proposed arrangement, the RC network 952 may just include a series arrangement of a resistor and a capacitor.

The operating status of the DC-DC converter (i.e., whether it is switching or not) may thus be detected by comparing the voltages at pins VOS and VSS. The voltage Vout received at pin VOS is internally offset upward (i.e., increased) by a voltage Vofs (e.g., Vofs=1 V) and then passed to the inverting input of the comparator COS1, which receives the voltage Vsec from pin VSS at its non-inverting input. When the DC-DC converter is switching, the output of comparator COS1 (herein referred to as a reset signal Reset) is a square wave signal with a low logic level when Vsec≈0 and a high logic level when voltage Vsec far exceeds voltage Vout. Signal Reset is passed to the timer TIMER_S so that a high logic level of signal Reset at the output of comparator COS1 resets the timer TIMER_S, thus when the DC-DC converter is switching the timer TIMER_S is continuously reset (and substantially disabled). This corresponds to operation of the SSSM 72 in the “RUN” state 722. When the DC-DC converter is not switching, voltage Vsec at pin VSS is equal to voltage Vout, therefore the output of comparator COS1 is steadily low and the timer TIMER_S is counting without being reset. If switching activity of the DC-DC converter is detected again before the timer TIMER_S reaches its end-of-count, nothing happens (that is, the SSSM 72 remains in the “RUN” state 722), even in case voltage Vfbs falls below the first threshold voltage Vths1. This latter event would cause the output of the comparator COS2 to go high, since comparator COS2 receives voltage Vfbs from pin FBS at its inverting input and voltage Vths1 at its non-inverting input. However, if voltage Vfbs falls below the second threshold voltage Vths2 (which is lower than voltage Vths1), this means that the primary side is staying inactive for long, most probably because the primary side controller 90 is in operating in the “SLEEP” state 716 (a proper selection of the output capacitor Cout of the DC-DC converter may ensure that this is definitely the case). If this happens, the output of the comparator COS3 (which receives voltage Vfbs from pin FBS at its inverting input and voltage Vths2 at its non-inverting input) will go high and trigger (e.g., via an OR logic gate 956) a monostable flip-flop 958, which will release a pulse (e.g., lasting a few μs). The pulse produced by flip-flop 958 is passed to the gate terminal of an internal switch SW1 (which is connected between pin VSS and ground) and will turn on the internal switch SW1, which will thus internally connect pin VSS (and thus voltage Vsec) to ground for the corresponding time interval (duration of the pulse), so that a current will flow through the inductance of the secondary winding L2, supplied by the output capacitor Cout of the DC-DC converter. When the switch SW1 turns off, the interruption of the current causes the voltage Vsec across the secondary winding L2 to reverse and bounce above the output voltage Vout. This voltage reversal is reflected on all the windings of the transformers, in particular on the auxiliary winding Naux. This is the wake-up pulse that is captured by the wake-up pulse detector of the primary controller 90, and makes the PSSM 71 transition from the “SLEEP” state 716 to the “RUN-OL” state 718.

It will be noted that, in case the secondary controller 95 embeds the control of the synchronous rectification (SR) as per the architecture of FIG. 8C, the switch SW1 may not be needed because the same effect can be obtained by turning on the synchronous rectifier transistor SR shown in FIG. 8C (insofar as it is connected as well between a node at voltage Vsec and ground). In this case, as exemplified in the circuit diagram of FIG. 11, the secondary controller 95 may include an OR logic gate 960 that receives the pulsed signal output by the metastable flip-flop 958 at a first input and receives the control signal SR_C of the synchronous rectifier as produced by the control circuit at a second input, and passes its output signal to a gate driver 962 of the synchronous rectifier, whose output is connected to an output pin SRGD of the secondary controller 95 that is configured to drive the gate terminal of the transistor SR.

Still by way of description of the operation of the secondary controller 95, consider now the case when, during an idle period, the timer TIMER_S reaches its end-of-count. The output of the timer TIMER_S is coupled to the set terminal of a set-reset (S-R) flip-flop 964 (and the reset terminal of the flip-flop 964 is coupled to the output of the comparator COS2). Therefore, when the timer TIMER_S reaches its end-of-count the flip-flop 964 is set, so that its data output terminal Q (producing a sleep signal DS-S) goes to a high logic value. The sleep signal DS-S is received by a supply voltage generator 966 which, in response to signal DS-S being high, disables all the supply voltages of the secondary controller 95 (e.g., voltage VDD_S received by the amplifier 954) except the supply rail VAA_S that supplies the comparators COS2, COS3 as well as the AND and OR gates, the monostable flip-flop 958 and the set-reset flip flop 964, which are intended to generate the wake-up pulse. In particular, the amplifier 954 is disabled, and its output transistor is forced off, so that the pin COMPH is substantially floating. In addition to that, the complemented data output terminal Q of the flip-flop 964 goes to a low logic value, which in turn opens the switch SW2 that connects the pin COMPL to ground. In this way, the RC network 952 is totally floating (e.g., floating at both sides), and its status is frozen. The current IF is null as desired, and the feedback loop is open. This corresponds to the “SLEEP” state 724 of the SSSM 72.

While the SSSM 72 is in the “SLEEP” state 724, the output voltage Vout drops and so does voltage Vfbs. As voltage Vfbs falls below the threshold voltage Vths1, the output of the comparator COS2 gets asserted (e.g., goes high). On the one hand, this will reset the set-reset flip-flop 964, which re-enables all the supply voltages generated by the supply voltage generator 966 so that all functional blocks (in particular, the error amplifier 954) are again up and running, and closes the switch SW2, so that the secondary side portion of the feedback loop is closed. On the other hand, since the sleep signal DS-S was also asserted (e.g., high), assertion of the output of comparator COS2 also triggers the monostable flip-flop 958 (insofar as a second input of the OR gate 956 is coupled to the output of an AND gate that receives as inputs the signal DS-S and the output from comparator COS2), which will release its pulse, thus originating the wake-up pulse as previously described. This operation corresponds to the transition of the SSSM 72 from the “SLEEP” state 724 to the “RUN2” state 726 and then to the “RUN” state 722. At the same time, on the primary side the PSSM 71 goes into the “RUN” state 712 too, and the feedback loop is again completely closed.

Purely by way of non-limiting example, the proposed architecture has been applied to a 65 W USB-PD compliant charger based on a flyback converter. Possible electrical specification of the flyback converter, parameters of the primary controller 90, and parameters of the secondary controller 95 are exemplified respectively in Tables I, II and III at the end of the present description. The Current Transfer Ratio (CTR) of the optocoupler is assumed to be 0.4 μA/μA.

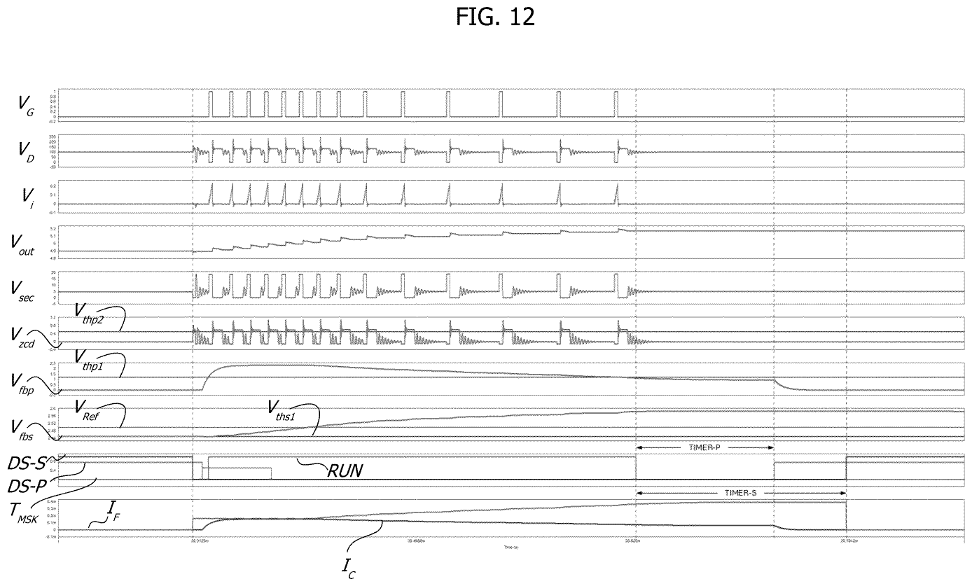

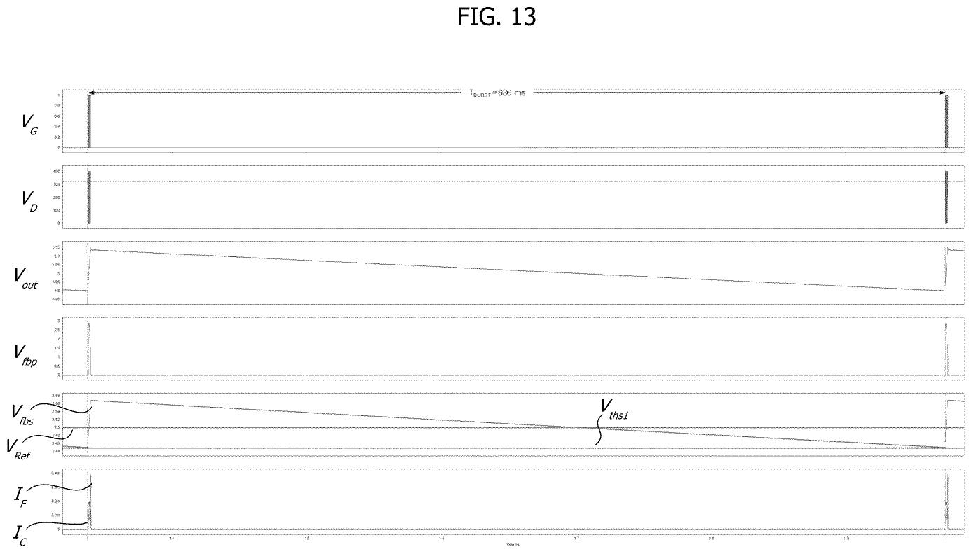

FIG. 12 is a time diagram including simulated waveforms exemplary of operation of a 65 W USB-PD compliant AC-DC charger having the architecture described herein and the parameters of Tables I, II and III. FIG. 12 shows the detail of a burst with the following signals: gate drive signal VG, drain voltage VD, current sensing voltage Vi, output voltage Vout, secondary voltage Vsec, zero-current detection voltage Vzcd, threshold voltage Vthp2, control voltage Vfbp, threshold voltage Vthp1, output partition voltage Vfbs, reference voltage VRef, threshold voltage Vths1, run signal RUN, sleep signal DS-S, sleep signal DS-P, pulse signal TMSK, current IF, current IC. FIG. 13 is a time diagram including simulated waveforms exemplary of burst operation of the 65 W USB-PD compliant AC-DC charger on a much longer time frame, and helps provide an estimate of the consumption of the SSR system when the output is loaded with 0.5 mW. The average values of currents IF and IC are 1.1 μA and 0.56 μA respectively, more than two orders of magnitude smaller than their value in the absence of the “SLEEP” states. Considering that current IF comes from the output voltage Vout (which, in embodiments, may be equal to 5 V) and that current IC ultimately comes from the supply voltage of the controller (which, in embodiments, may be equal to 10 V), the associated power consumptions can be estimated at 5.5 μW and 5.6 μW respectively. The total consumption associated to the SSR system can thus be estimated at 11.1 μW. This value is already negligible if compared to the other fixed sources of power consumption (e.g., the primary controller may absorb 50 μA·10 V=500 μW, the secondary controller may absorb 50 μA·5 V=250 μW, and the output divider may absorb 80 μA·5 V=400 μW, then 1.15 mW in total). Further reducing the output load, the repetition time of the bursts (TBURST) will get longer, which will reduce the average values of currents IF and IC even further.

Therefore, thanks to the architecture exemplified herein, an SSR feedback loop is no longer an obstacle to meeting the “zero standby power consumption” target (e.g., a standby power consumption lower than 5 mW). Considering that the consumption of the output divider (IR=80 μA) can be easily reduced, this ability will be essentially related to reducing the quiescent currents of the primary and secondary controllers to extremely low values, e.g., below 50 μA.

Therefore, one or more embodiments as described herein may provide a DC-DC converter circuit (e.g., for use in a switched-mode power supply such as an online power supply) with a precise SSR feedback loop and very low power consumption at standby (e.g., less than 5 mW at standby).

Without prejudice to the underlying principles, the details and embodiments may vary, even significantly, with respect to what has been described by way of example only, without departing from the extent of protection.

The extent of protection is determined by the annexed claims.

### Tables

TABLE I

| Parameter | Symbol | Value | Unit |
|---|---|---|---|
| Mains voltage range | V_{in, min}-V_{in, max} | 88-264 | Vᵣₘₛ |
| Mains frequency | f_{L} | 50 | Hz |
| Output voltage range | V_{out, min}-V_{out, max} | 5-20 | V |
| Output voltage during standby | V_{out, sby} | 5 | V |
| conditions | | | |
| Maximum output current | I_{out.max} | 3.25 | A |
| Minimum switching frequency (@ | f_{sw, min} | 50 | kHz |
| V_{in, min}, V_{out, max}) | | | |
| Reflected voltage (@ V_{out, max}) | V_{R} | 140 | V |
| Secondary rectifier voltage drop | V_{f} | 0.1 | V |

TABLE II

| Parameter | Symbol | Value | Unit |
|---|---|---|---|
| Internal current source for phototransistor | I_{C} | 220 | μA |
| bias | | | |
| Burst-mode comparator (COP1) threshold | Vₜₕₚ₁ | 1.2 | V |
| Burst-mode comparator hysteresis | Hys | 50 | mV |
| Wake-up pulse detection threshold | Vₜₕₚ₂ | 0.5 | V |
| RUN-OL state dwell time | T_{MSK} | 50 | μs |
| Sleep mode delay | TIMER_P | 100 | μs |
| Quiescent consumption in sleep mode | I_{q} | 50 | μA |

TABLE III

| Parameter | Symbol | Value | Unit |
|---|---|---|---|
| Output divider current consumption @, | I_{R} | 80 | μA |
| V_{out, sby} | | | |
| Error amplifier reference voltage | V_{Ref} | 2.5 | V |
| Error amplifier transconductance | gₘ | 10 | mS |
| Out-of-sleep-mode threshold | Vₜₕₛ₁ | 2.45 | V |
| Wake-up pulse forcing threshold | Vₜₕₛ₂ | 2.425 | V |
| Wake-up pulse duration | T_{WKP} | 2 | μs |
| Wake-up pulse switch resistance | R_{WKP} | 1 | Ω |
| Offset voltage of switching detector | V_{OFS} | 1 | V |
| comparator | | | |
| Sleep mode delay | TIMER_S | 150 | μs |
| Quiescent consumption in sleep mode | I_{q} | 50 | μA |

What is claimed is:

1. A controller circuit for a primary side of an isolated direct current (DC)-DC converter, the controller circuit comprising:
a pulse width modulation (PWM) generator configured to sense a feedback voltage indicative of an output voltage of the isolated DC-DC converter, and to generate a PWM control signal for controlling a switching activity of the DC-DC converter;
a supply voltage generator configured to generate a first supply voltage for the PWM generator and a second supply voltage for a wake-up pulse detector; and
control circuitry comprising the wake-up pulse detector, the wake-up pulse detector configured to sense a zero-current detection voltage indicative of a voltage across an auxiliary transformer winding of the isolated DC-DC converter, and the control circuitry configured to operate the controller circuit in:
a first state wherein the supply voltage generator generates the first supply voltage and the second supply voltage, and wherein the PWM generator is enabled;
a second state wherein the supply voltage generator generates the first supply voltage and the second supply voltage, and wherein the PWM generator is disabled;
a third state wherein the supply voltage generator does not generate the first supply voltage and generates the second supply voltage, and wherein the PWM generator is disabled; and
a fourth state wherein the supply voltage generator generates the first supply voltage and the second supply voltage, and wherein the PWM generator is enabled.

2. The controller circuit of claim 1, wherein the control circuitry is further configured to:
in response to the feedback voltage being higher than a first threshold voltage, operate the controller circuit in the first state;
in response to the feedback voltage falling below the first threshold voltage, transition operation of the controller circuit to the second state;
in response to the feedback voltage remaining below the first threshold voltage for a first time interval after transition to the second state, transition operation of the controller circuit to the third state;
in response to the zero-current detection voltage rising above a second threshold voltage, transition operation of the controller circuit to the fourth state, and maintain operation of the controller circuit in the fourth state for a second time interval; and
in response to the second time interval elapsing after the transition to the fourth state, transition operation of the controller circuit to the first state.

3. The controller circuit of claim 2, wherein the control circuitry comprises:
a first comparator configured to compare the feedback voltage to the first threshold voltage and to assert a first signal in response to the feedback voltage being higher than the first threshold voltage, the first comparator being supplied by the first supply voltage;
a timer circuit configured to be disabled when the first signal is asserted and to be enabled when the first signal is de-asserted, the timer circuit being configured to assert a first timing signal when reaching the first time interval, the timer circuit being supplied by the first supply voltage; and
a set-reset flip-flop having a reset terminal configured to receive the first timing signal and a complemented data output terminal configured to generate a deep-sleep signal, the set-reset flip-flop being supplied by the second supply voltage;
wherein the PWM generator is enabled in response to the first signal being asserted; and
wherein the supply voltage generator does not generate the first supply voltage in response to the deep-sleep signal being asserted.

4. The controller circuit of claim 3, wherein the wake-up pulse detector comprises:
a second comparator configured to compare the zero-current detection voltage to the second threshold voltage and to assert a second signal in response to the zero-current detection voltage being higher than the second threshold voltage, the second comparator being supplied by the second supply voltage;
an AND logic gate configured to generate a third signal by applying AND logic processing to the second signal and to the deep-sleep signal;
the set-reset flip-flop having a set terminal configured to receive the third signal and a data output terminal configured to generate a fourth signal;
a monostable flip-flop configured to generate a pulsed signal having a duration equal to the second time interval in response to assertion of the fourth signal; and
an OR logic gate configured to generate an enable signal for the PWM generator by applying OR logic processing to the first signal and to the pulsed signal.

5. The controller circuit of claim 4, further comprising:
a first input pin configured to couple to an anode terminal of a signal receiver of an external isolator to receive the feedback voltage, wherein the supply voltage generator is configured to source a current to the first input pin; and
a second input pin configured to receive the zero-current detection voltage.

6. The controller circuit of claim 5, wherein the first comparator is coupled to the first input pin, and the second comparator is coupled to the second input pin.

7. The controller circuit of claim 5, wherein the third state includes the supply voltage generator not sourcing the current to the first input pin.

8. A controller circuit for a secondary side of an isolated direct current (DC)-DC converter, the controller circuit comprising:
an error amplifier configured to sense a feedback voltage indicative of an output voltage of the isolated DC-DC converter, and generate an error signal based on a difference between a reference voltage and the feedback voltage;
a switching detector configured to compare a secondary-side transformer voltage from a secondary transformer winding of the isolated DC-DC converter to the output voltage, and detect switching activity of the isolated DC-DC converter based on the secondary-side transformer voltage crossing the output voltage;
a wake-up pulse generator configured to sense the feedback voltage;
a supply voltage generator configured to generate a first supply voltage for the error amplifier, and a second supply voltage for the switching detector and the wake-up pulse generator; and
control circuitry including the switching detector and the wake-up pulse generator, the control circuitry configured to operate the controller circuit in:
a first state wherein the supply voltage generator is configured to generate the first supply voltage and the second supply voltage, wherein the error amplifier is enabled to generate the error signal, and sink a current;
a second state wherein the supply voltage generator does not generate the first supply voltage and generates the second supply voltage, wherein the error amplifier is disabled and does not sink the current; and
a third state wherein the wake-up pulse generator generates a wake-up pulse.

9. The controller circuit of claim 8, wherein the control circuit is configured to:
in response to detecting the switching activity during a detection time interval, operate the controller circuit in the first state;
in response to switching inactivity being detected during the detection time interval, transition operation of the controller circuit to the second state;
in response to the feedback voltage falling below a first threshold voltage while the controller circuit operates in the second state, transition operation of the controller circuit to the third state;
in response to the feedback voltage falling below a second threshold voltage while the controller circuit operates in the first state, transition operation of the controller circuit to the third state; and
in response to the wake-up pulse being generated, transition operation of the controller circuit to the first state.

10. The controller circuit of claim 9, wherein the second threshold voltage is lower than the first threshold voltage.

11. The controller circuit of claim 9, further comprising:
a first input pin configured to receive the feedback voltage;
a second input pin configured to receive the secondary-side transformer voltage;
a third input pin configured to receive the output voltage;
a first output pin configured to be coupled to a cathode terminal of a signal transmitter of an external isolator and to an anode terminal of an external compensation circuit; and
a second output pin configured to be coupled to a cathode terminal of the external compensation circuit.

12. The controller circuit of claim 11, wherein:
the control circuitry is configured to detect the switching activity and the switching inactivity at the second input pin;
the first state includes the error amplifier being configured to generate the error signal at the first output pin, and sink the current from the first output pin, and the second output pin being connected to a ground; and
the second state includes floating the first output pin and the second output pin.

13. The controller circuit of claim 11, wherein the wake-up pulse generator generates the wake-up pulse by:
connecting to a ground and subsequently impulsively disconnecting from the ground the second input pin; or
asserting and subsequently impulsively de-asserting a gate driving signal for a synchronous rectifier of the isolated DC-DC converter.

14. The controller circuit of claim 11, wherein:
the switching detector comprises a first comparator coupled to the second input pin and to the third input pin, and configured to assert, respectively de-assert, a reset signal in response the secondary-side transformer voltage being higher, respectively lower, than the output voltage plus an offset voltage; and
the control circuitry comprises:
a timer circuit configured to be reset in response to assertion of the reset signal, the timer circuit being configured to assert a first timing signal when reaching the detection time interval; and
a set-reset flip-flop having a set terminal configured to receive the first timing signal, a data output terminal configured to generate a deep-sleep signal, and a complemented data output terminal configured to control a switch coupled between the second output pin and a ground, the set-reset flip-flop being supplied by the second supply voltage;
wherein the supply voltage generator does not generate the first supply voltage in response to the deep-sleep signal being asserted.

15. The controller circuit of claim 14, wherein the wake-up pulse generator comprises:
a second comparator coupled to the first input pin and configured to compare the feedback voltage to the first threshold voltage and to assert a first signal in response to the feedback voltage being lower than the first threshold voltage, the second comparator being supplied by the second supply voltage;
the set-reset flip-flop having a reset terminal configured to receive the first signal;
a monostable flip-flop configured to generate a pulsed signal in response to assertion of the first signal and assertion of the deep-sleep signal; and
a further switch coupled between the second input pin and the ground and having a control terminal configured to receive the pulsed signal, or a gate driver circuit configured to generate the gate driving signal based on the pulsed signal.

16. The controller circuit of claim 14, wherein the wake-up pulse generator comprises:
a third comparator coupled to the first input pin and configured to compare the feedback voltage to the second threshold voltage and to assert a second signal in response to the feedback voltage being lower than the second threshold voltage, the third comparator being supplied by the second supply voltage;
a monostable flip-flop configured to generate a pulsed signal in response to assertion of the second signal; and
a further switch coupled between the second input pin and the ground and having a control terminal configured to receive the pulsed signal, or a gate driver circuit configured to generate the gate driving signal based on the pulsed signal.

17. A method of operating an isolated direct current (DC)-DC converter, the method comprising:
receiving a primary feedback voltage indicative of an output voltage of the isolated DC-DC converter at a first input pin of a primary-side controller circuit;
receiving a zero-current detection voltage indicative of a voltage across an auxiliary winding of the isolated DC-DC converter at a second input pin of the primary-side controller circuit;
receiving a secondary feedback voltage indicative of the output voltage of the isolated DC-DC converter at a first input pin of a secondary-side controller circuit;
receiving a secondary-side transformer voltage from a secondary winding of the isolated DC-DC converter at a second input pin of the secondary-side controller circuit;
receiving the output voltage of the isolated DC-DC converter at a third input pin of the secondary-side controller circuit;
executing a primary-side state machine by primary-side control circuitry; and
executing a secondary-side state machine by secondary-side control circuitry, the secondary-side state machine comprising:
a first secondary state including providing an error signal at a first output pin of the secondary-side controller circuit, and sinking a current from the first output pin, and connecting a second output pin of the secondary-side controller circuit is connected to a ground of a secondary-side; and
a second secondary state including floating the first output pin and the second output pin of the secondary-side controller circuit.

18. The method of claim 17, further comprising executing the primary-side state machine to:
in response to the primary feedback voltage being higher than a primary first threshold voltage, operating the primary-side controller circuit in a first primary state wherein a primary supply voltage generator generates a primary first supply voltage and a primary second supply voltage, and wherein a pulse width modulation (PWM) generator is enabled;
in response to the primary feedback voltage falling below the primary first threshold voltage, transitioning operation of the primary-side controller circuit to a second primary state wherein the primary supply voltage generator generates the primary first supply voltage and the primary second supply voltage, and wherein the PWM generator is disabled;
in response to the primary feedback voltage remaining below the primary first threshold voltage for a first time interval after transition to the second primary state, transitioning operation of the primary-side controller circuit to a third primary state wherein the primary supply voltage generator does not generate the primary first supply voltage and generates the primary second supply voltage and does not source the current to the first input pin of the primary-side controller circuit, and wherein the PWM generator is disabled;
in response to the zero-current detection voltage rising above a primary second threshold voltage, transitioning operation of the primary-side controller circuit to a fourth primary state wherein the primary supply voltage generator generates the primary first supply voltage and the primary second supply voltage, and wherein the PWM generator is enabled, and maintaining operation of the primary-side controller circuit into the fourth primary state for a second time interval; and
in response to the second time interval elapsing after the transition to the fourth primary state, transitioning operation of the primary-side controller circuit to the first primary state.

19. The method of claim 18, further comprising executing the secondary-side state machine to:
in response to switching activity being detected at the second input pin of the secondary-side controller circuit during a detection time interval, operating the secondary-side controller circuit in the first secondary state wherein a secondary supply voltage generator generates a secondary first supply voltage and a secondary second supply voltage, wherein an error amplifier is enabled to generate the error signal at the first output pin of the secondary-side controller circuit and to sink the current from the first output pin;
in response to switching inactivity being detected at the second input pin of the secondary-side controller circuit during the detection time interval, transitioning operation of the secondary-side controller circuit to the second secondary state wherein the secondary supply voltage generator does not generate the secondary first supply voltage and generates the secondary second supply voltage, wherein the error amplifier is disabled and does not sink the current, and;
in response to the secondary feedback voltage falling below a secondary first threshold voltage while the secondary-side controller circuit operates in the second secondary state, transitioning operation of the secondary-side controller circuit to a third secondary state wherein a wake-up pulse generator generates a wake-up pulse by connecting to the ground and subsequently impulsively disconnecting from the ground the second input pin of the secondary-side controller circuit or by asserting and subsequently impulsively de-asserting a gate driving signal for a synchronous rectifier of the DC-DC converter;
in response to the secondary feedback voltage falling below a secondary second threshold voltage while the secondary-side controller circuit operates in the first secondary state, transitioning operation of the secondary-side controller circuit to the third secondary state; and
in response to the wake-up pulse being generated, transitioning operation of the secondary-side controller circuit to the first secondary state.

20. The method of claim 19, further comprising regulating, by the isolated DC-DC converter, a bus DC voltage generated by a rectification stage from an input alternating current (AC) voltage, to produce an output DC voltage provided to electrical load.
